(19) United States
(12) Patent Application Publication
(10) Pub. No.: US 2018/0053003 A1
(43) Pub. Date: Feb. 22, 2018

(54) SELECTIVELY OBFUSCATING A PORTION OF A STREAM OF VISUAL MEDIA THAT IS STREAMED TO AT LEAST ONE SINK DURING A SCREEN-SHARING SESSION

(71) Applicant: QUALCOMM Incorporated, San Diego, CA (US)

(72) Inventor: Sreeja NAIR, San Jose, CA (US)

(21) Appl. No.: 15/240,329

(22) Filed: Aug. 18, 2016

(51) Int. Cl. G06F 21/60; G06T 3/00; G06F 3/14; H04W 12/02

(52) U.S. Cl. CPC G06F 21/60; G06T 3/0093; G06F 3/048; H04W 12/02; G06F 3/1454

(57) ABSTRACT

In an embodiment, a Source is engaged in a screen-sharing session with at least one Sink whereby the Source is streaming a version of media being displayed at the Source to the at least one Sink for presentation thereon. The Source detects a screen section that is viewable within media to be streamed to the at least one Sink that conveys user input at the Source (e.g., the Source user entering a password, etc.). In response to the detection, the Source obfuscates (e.g., blurs or renders unrecognizable) the detected screen section within the media streamed to the at least one Sink, while still permitting a non-obfuscated version of the detected screen section to be displayed locally at the Source.

### BACKGROUND

### 1. Field of the Disclosure

Embodiments relate to selectively obfuscating a portion of a stream of visual media that is streamed to at least one sink during a screen-sharing session.

### 2. Description of the Related Art

Various protocols exist for streaming media (e.g., video, audio, etc.) from a source device (hereinafter “Source”, such as a UE such as a phone, desktop computer, laptop, etc.) to one or more target display devices (referred to as a sink device or “Sink”). For example, a desktop or laptop computer may share a respective display screen with one or more target computers in a server-mediated session (e.g., GoToMeeting, etc.), or the streaming may occur via a local wireless media distribution scheme (e.g., Miracast). In a screen-sharing session, some or all of the media that is displayed at the Source is also sent to one or more Sinks. At times, a user of the Source may be prompted to enter private information (e.g., a passcode, a password, etc.) that he/she does not wish to share with the Sink(s) involved in the screen-sharing session and/or with one or more users in proximity to the Sink(s).

In these instances, the Source user may take manual action to protect the private information. Examples of how the Source user can protect the private information include refraining from entering the private information at all (e.g., in which case, the user may not be able to access certain features until the screen-sharing session is terminated, such as logging into an online account, etc.), terminating the screen-sharing session so the private information can be entered without being exposed to the Sink(s), or (if possible) dragging the screen section where the private information is entered to a different area of the Source's display screen that is not being shared with the Sink(s). However, it is difficult to protect private information from being shared with the Sink(s) if the screen section where the private information is being entered at the Source is shared with the Sink(s).

### SUMMARY

An embodiment is directed to a method of operating a Source, including establishing a screen-sharing session with at least one Sink, displaying a first stream of visual media on a display screen of the Source, streaming, during the screen-sharing session, a second stream of visual media that includes some or all of the first stream of visual media to the at least one Sink for presentation thereon, detecting that a screen section that is viewable within the first and second streams of visual media is configured to convey user input received via a user input interface associated with the Source, obfuscating a visual representation of the detected screen section within the second stream of visual media, displaying the first stream of visual media with a non-obfuscated visual representation of the detected screen section and streaming, in response to the detecting during the screen-sharing session, the second stream of visual media with the obfuscated visual representation of the detected screen section to the at least one Sink for presentation thereon.

Another embodiment is directed to a Source, including at least one processor coupled to a memory, transceiver circuitry and user interface output circuitry configured to present information, the at least one processor configured to establish a screen-sharing session with at least one Sink, display a first stream of visual media on a display screen of the Source, stream, during the screen-sharing session, a second stream of visual media that includes some or all of the first stream of visual media to the at least one Sink for presentation thereon, detect that a screen section that is viewable within the first and second streams of visual media is configured to convey user input received via a user input interface associated with the Source, obfuscate a visual representation of the detected screen section within the second stream of visual media, display the first stream of visual media with a non-obfuscated visual representation of the detected screen section and stream, in response to the detection during the screen-sharing session, the second stream of visual media with the obfuscated visual representation of the detected screen section to the at least one Sink for presentation thereon.

Another embodiment is directed to a non-transitory computer-readable medium containing instructions stored thereon which, when executed by a Source, cause the Source to perform operations, the instructions including at least one instruction to cause the Source to establish a screen-sharing session with at least one Sink, at least one instruction to cause the Source to display a first stream of visual media on a display screen of the Source, at least one instruction to cause the Source to stream, during the screen-sharing session, a second stream of visual media that includes some or all of the first stream of visual media to the at least one Sink for presentation thereon, at least one instruction to cause the Source to detect that a screen section that is viewable within the first and second streams of visual media is configured to convey user input received via a user input interface associated with the Source, at least one instruction to cause the Source to obfuscate a visual representation of the detected screen section within the second stream of visual media, at least one instruction to cause the Source to display the first stream of visual media with a non-obfuscated visual representation of the detected screen section and at least one instruction to cause the Source to stream, in response to the detection during the screen-sharing session, the second stream of visual media with the obfuscated visual representation of the detected screen section to the at least one Sink for presentation thereon.

### BRIEF DESCRIPTION OF THE DRAWINGS

A more complete appreciation of embodiments of the disclosure will be readily obtained as the same becomes better understood by reference to the following detailed description when considered in connection with the accompanying drawings which are presented solely for illustration and not limitation of the disclosure, and in which:

FIG. 1 illustrates a high-level system architecture of a wireless communications system in accordance with an embodiment of the disclosure.

FIG. 2 illustrates examples of user equipments (UEs) in accordance with embodiments of the disclosure.

FIG. 3 illustrates a communications device that includes structural components in accordance with an embodiment of the disclosure.

FIG. 4 illustrates a server in accordance with an embodiment of the disclosure.

FIG. 5A illustrates a screen-sharing session in accordance with an embodiment of the disclosure.

FIG. 5B illustrates a screen-sharing session in accordance with another embodiment of the disclosure.

FIG. 5C illustrates a screen-sharing session in accordance with another embodiment of the disclosure.

FIG. 6 illustrates a process of streaming media from a Source to at least one Sink in accordance with an embodiment of the disclosure.

FIGS. 7A-7B illustrate an example framework to facilitate a screen-minor session in accordance with an embodiment of the disclosure.

FIG. 8A illustrates a screen-sharing session in accordance with an embodiment of the disclosure.

FIG. 8B illustrates a screen-sharing session in accordance with another embodiment of the disclosure.

FIG. 8C illustrates a screen-sharing session in accordance with another embodiment of the disclosure.

FIG. 9 illustrates an example implementation of the process of FIG. 6 in accordance with an embodiment of the disclosure.

FIG. 10 illustrates a flow of media during a screen-sharing session when obfuscation of a screen section is not being performed in accordance with an embodiment of the disclosure.

FIG. 11 illustrates a flow of media during a screen-sharing session when obfuscation of a screen section is being performed in accordance with an embodiment of the disclosure.

### DETAILED DESCRIPTION

Aspects of the disclosure are disclosed in the following description and related drawings directed to specific embodiments of the disclosure. Alternate embodiments may be devised without departing from the scope of the disclosure. Additionally, well-known elements of the disclosure will not be described in detail or will be omitted so as not to obscure the relevant details of the disclosure.

The words “exemplary” and/or “example” are used herein to mean “serving as an example, instance, or illustration.” Any embodiment described herein as “exemplary” and/or “example” is not necessarily to be construed as preferred or advantageous over other embodiments. Likewise, the term “embodiments of the disclosure” does not require that all embodiments of the disclosure include the discussed feature, advantage or mode of operation.

Further, many embodiments are described in terms of sequences of actions to be performed by, for example, elements of a computing device. It will be recognized that various actions described herein can be performed by specific circuits (e.g., application specific integrated circuits (ASICs)), by program instructions being executed by one or more processors, or by a combination of both. Additionally, these sequence of actions described herein can be considered to be embodied entirely within any form of computer-readable storage medium having stored therein a corresponding set of computer instructions that upon execution would cause an associated processor to perform the functionality described herein. Thus, the various aspects of the disclosure may be embodied in a number of different forms, all of which have been contemplated to be within the scope of the claimed subject matter. In addition, for each of the embodiments described herein, the corresponding form of any such embodiments may be described herein as, for example, “logic configured to” perform the described action.

A client device, referred to herein as a user equipment (UE), may be mobile or stationary, and may communicate with a wired access network and/or a radio access network (RAN). As used herein, the term “UE” may be referred to interchangeably as an “access terminal” or “AT”, a “wireless device”, a “subscriber device”, a “subscriber terminal”, a “subscriber station”, a “user terminal” or UT, a “mobile device”, a “mobile terminal”, a “mobile station” and variations thereof. In an embodiment, UEs can communicate with a core network via the RAN, and through the core network the UEs can be connected with external networks such as the Internet. Of course, other mechanisms of connecting to the core network and/or the Internet are also possible for the UEs, such as over wired access networks, WiFi networks (e.g., based on IEEE 802.11, etc.) and so on. UEs can be embodied by any of a number of types of devices including but not limited to cellular telephones, personal digital assistants (PDAs), pagers, laptop computers, desktop computers, PC cards, compact flash devices, external or internal modems, wireless or wireline phones, and so on. A communication link through which UEs can send signals to the RAN is called an uplink channel (e.g., a reverse traffic channel, a reverse control channel, an access channel, etc.). A communication link through which the RAN can send signals to UEs is called a downlink or forward link channel (e.g., a paging channel, a control channel, a broadcast channel, a forward traffic channel, etc.). As used herein the term traffic channel (TCH) can refer to either an uplink/reverse or downlink/forward traffic channel.

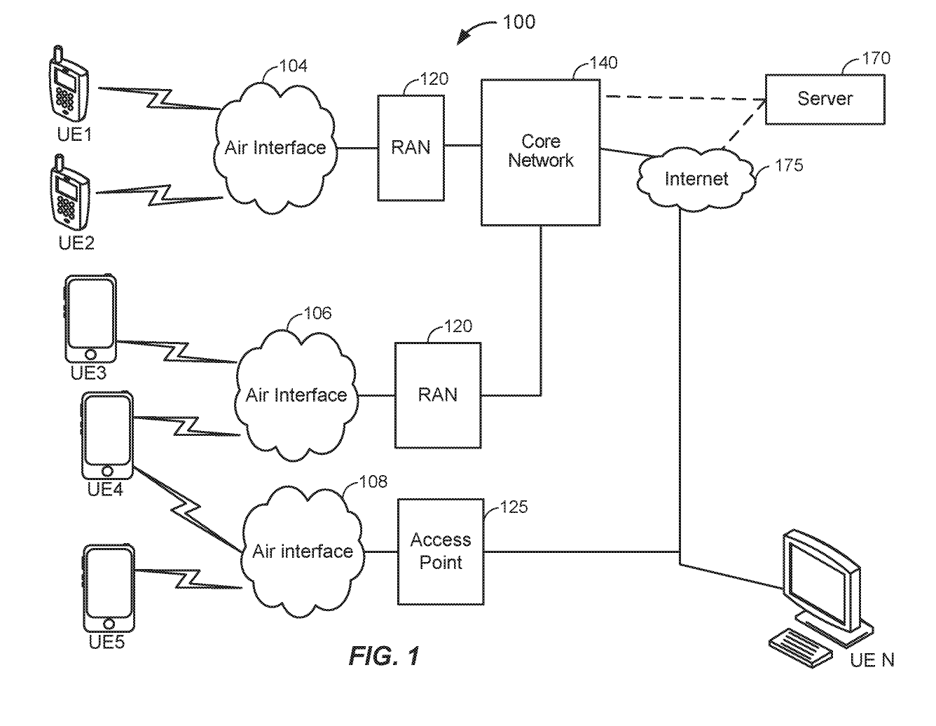

FIG. 1 illustrates a high-level system architecture of a wireless communications system 100 in accordance with an embodiment of the disclosure. The wireless communications system 100 contains UEs 1 . . . N. For example, in FIG. 1, UEs 1 . . . 2 are illustrated as cellular calling phones, UEs 3 . . . 5 are illustrated as cellular touchscreen phones or smart phones, and UE N is illustrated as a desktop computer or PC.

Referring to FIG. 1, UEs 1 . . . N are configured to communicate with an access network (e.g., a RAN 120, an access point 125, etc.) over a physical communications interface or layer, shown in FIG. 1 as air interfaces 104, 106, 108 and/or a direct wired connection. The air interfaces 104 and 106 can comply with a given cellular communications protocol (e.g., CDMA, EVDO, eHRPD, GSM, EDGE, W-CDMA, LTE, etc.), while the air interface 108 can comply with a wireless IP protocol (e.g., IEEE 802.11). The RAN 120 may include a plurality of access points that serve UEs over air interfaces, such as the air interfaces 104 and 106. The access points in the RAN 120 can be referred to as access nodes or ANs, access points or APs, base stations or BSs, Node Bs, eNode Bs, and so on. These access points can be terrestrial access points (or ground stations), or satellite access points. The RAN 120 may be configured to connect to a core network 140 that can perform a variety of functions, including bridging circuit switched (CS) calls between UEs served by the RAN 120 and other UEs served by the RAN 120 or a different RAN altogether, and can also mediate an exchange of packet-switched (PS) data with external networks such as Internet 175.

The Internet 175, in some examples includes a number of routing agents and processing agents (not shown in FIG. 1 for the sake of convenience). In FIG. 1, UE N is shown as connecting to the Internet 175 directly (i.e., separate from the core network 140, such as over an Ethernet connection of WiFi or 802.11-based network). The Internet 175 can thereby function to bridge packet-switched data communications between UEs 1 . . . N via the core network 140. Also shown in FIG.1 is the access point 125 that is separate from the RAN 120. The access point 125 may be connected to the Internet 175 independent of the core network 140 (e.g., via an optical communications system such as FiOS, a cable modem, etc.). The air interface 108 may serve UE 4 or UE 5 over a local wireless connection, such as IEEE 802.11 in an example. UE N is shown as a desktop computer with a wired connection to the Internet 175, such as a direct connection to a modem or router, which can correspond to the access point 125 itself in an example (e.g., for a WiFi router with both wired and wireless connectivity).

Referring to FIG. 1, a server 170 is shown as connected to the Internet 175, the core network 140, or both. The server 170 can be implemented as a plurality of structurally separate servers, or alternately may correspond to a single server. As will be described below in more detail, the server 170 is configured to support one or more communication services (e.g., Voice-over-Internet Protocol (VoIP) sessions, Push-to-Talk (PTT) sessions, group communication sessions, social networking services, etc.) for UEs that can connect to the server 170 via the core network 140 and/or the Internet 175, and/or to provide content (e.g., web page downloads) to the UEs.

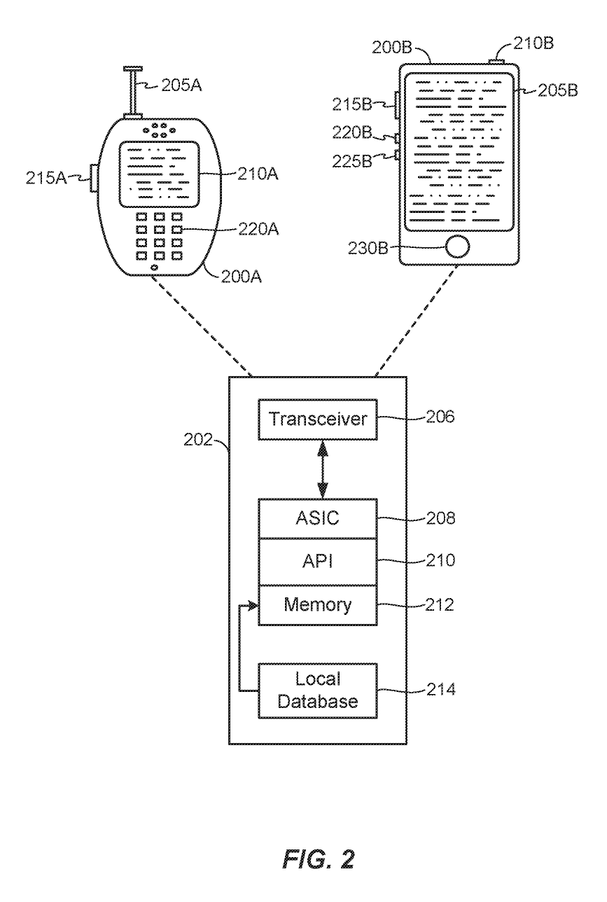

FIG. 2 illustrates examples of UEs (i.e., client devices) in accordance with embodiments of the disclosure. Referring to FIG. 2, UE 200A is illustrated as a calling telephone and UE 200B is illustrated as a touchscreen device (e.g., a smart phone, a tablet computer, etc.). As shown in FIG. 2, an external casing of UE 200A is configured with an antenna 205A, display 210A, at least one button 215A (e.g., a PTT button, a power button, a volume control button, etc.) and a keypad 220A among other components, as is known in the art. Also, an external casing of UE 200B is configured with a touchscreen display 205B, peripheral buttons 210B, 215B, 220B and 225B (e.g., a power control button, a volume or vibrate control button, an airplane mode toggle button, etc.), and at least one front-panel button 230B (e.g., a Home button, etc.), among other components, as is known in the art. While not shown explicitly as part of UE 200B, UE 200B can include one or more external antennas and/or one or more integrated antennas that are built into the external casing of UE 200B, including but not limited to WiFi antennas, cellular antennas, satellite position system (SPS) antennas (e.g., global positioning system (GPS) antennas), and so on.

While internal components of UEs such as UEs 200A and 200B can be embodied with different hardware configurations, a basic high-level UE configuration for internal hardware components is shown as platform 202 in FIG. 2. The platform 202 can receive and execute software applications, data and/or commands transmitted from the RAN 120 that may ultimately come from the core network 140, the Internet 175 and/or other remote servers and networks (e.g., application server 170, web URLs, etc.). The platform 202 can also independently execute locally stored applications without RAN interaction. The platform 202 can include a transceiver 206 operably coupled to an application specific integrated circuit (ASIC) 208, or other processor, microprocessor, logic circuit, or other data processing device. The ASIC 208 or other processor executes an application programming interface (API) 210 layer that interfaces with any resident programs in a memory 212 of the wireless device. The memory 212 can be comprised of read-only or random-access memory (RAM and ROM), EEPROM, flash cards, or any memory common to computer platforms. The platform 202 also can include a local database 214 that can store applications not actively used in the memory 212, as well as other data. The local database 214 is typically a flash memory cell, but can be any secondary storage device as known in the art, such as magnetic media, EEPROM, optical media, tape, soft or hard disk, or the like.

Accordingly, an embodiment of the disclosure can include a UE (e.g., UE 200A, 200B, etc.) including the ability to perform the functions described herein. As will be appreciated by those skilled in the art, the various logic elements can be embodied in discrete elements, software modules executed on a processor or any combination of software and hardware to achieve the functionality disclosed herein. For example, the ASIC 208, the memory 212, the API 210 and the local database 214 may all be used cooperatively to load, store and execute the various functions disclosed herein and thus the logic to perform these functions may be distributed over various elements. Alternatively, the functionality could be incorporated into one discrete component. Therefore, the features of the UEs 200A and 200B in FIG. 2 are to be considered merely illustrative and the disclosure is not limited to the illustrated features or arrangement.

The wireless communications between UEs 200A and/or 200B and the RAN 120 can be based on different technologies, such as CDMA, W-CDMA, time division multiple access (TDMA), frequency division multiple access (FDMA), Orthogonal Frequency Division Multiplexing (OFDM), GSM, or other protocols that may be used in a wireless communications network or a data communications network. As discussed in the foregoing and known in the art, voice transmission and/or data can be transmitted to the UEs from the RAN using a variety of networks and configurations. Accordingly, the illustrations provided herein are not intended to limit the embodiments of the disclosure and are merely to aid in the description of aspects of embodiments of the disclosure.

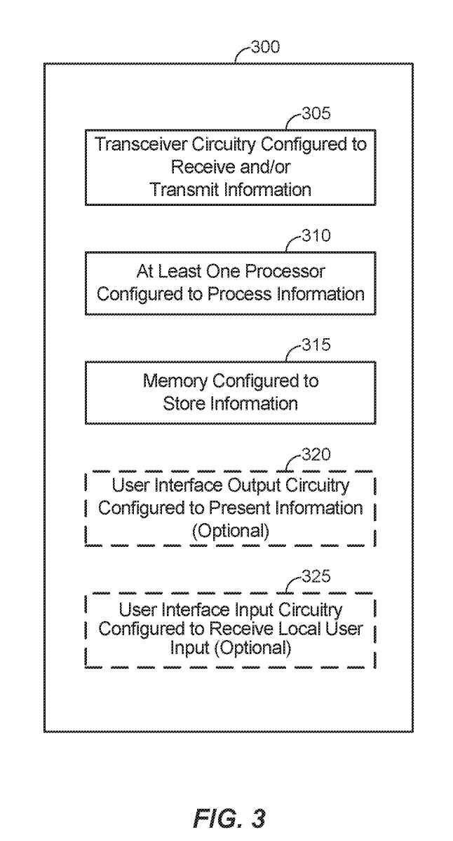

FIG. 3 illustrates a communications device 300 that includes structural components in accordance with an embodiment of the disclosure. The communications device 300 can correspond to any of the above-noted communications devices, including but not limited to UEs 1 . . . N, UEs 200A and 200B, any component included in the RAN 120 such as base stations, access points or eNodeBs, any component of the core network 140, any component coupled to the Internet 175 (e.g., the application server 170), and so on. Thus, communications device 300 can correspond to any electronic device that is configured to communicate with (or facilitate communication with) one or more other entities over the wireless communications systems 100 of FIG. 1.

Referring to FIG. 3, the communications device 300 includes transceiver circuitry configured to receive and/or transmit information 305. In an example, if the communications device 300 corresponds to a wireless communications device (e.g., UE 200A or UE 200B), the transceiver circuitry configured to receive and/or transmit information 305 can include a wireless communications interface (e.g., Bluetooth, WiFi, WiFi Direct, Long-Term Evolution (LTE) Direct, etc.) such as a wireless transceiver and associated hardware (e.g., an RF antenna, a MODEM, a modulator and/or demodulator, etc.). In another example, the transceiver circuitry configured to receive and/or transmit information 305 can correspond to a wired communications interface (e.g., a serial connection, a USB or Firewire connection, an Ethernet connection through which the Internet 175 can be accessed, etc.). Thus, if the communications device 300 corresponds to some type of network-based server (e.g., the application server 170), the transceiver circuitry configured to receive and/or transmit information 305 can correspond to an Ethernet card, in an example, that connects the network-based server to other communication entities via an Ethernet protocol. In a further example, the transceiver circuitry configured to receive and/or transmit information 305 can include sensory or measurement hardware by which the communications device 300 can monitor its local environment (e.g., an accelerometer, a temperature sensor, a light sensor, an antenna for monitoring local RF signals, etc.). The transceiver circuitry configured to receive and/or transmit information 305 can also include software that, when executed, permits the associated hardware of the transceiver circuitry configured to receive and/or transmit information 305 to perform its reception and/or transmission function(s). However, the transceiver circuitry configured to receive and/or transmit information 305 does not correspond to software alone, and the transceiver circuitry configured to receive and/or transmit information 305 relies at least in part upon structural hardware to achieve its functionality. Moreover, the transceiver circuitry configured to receive and/or transmit information 305 may be implicated by language other than “receive ”and “transmit”, so long as the underlying function corresponds to a receive or transmit function. For example, functions such as obtaining, acquiring, retrieving, measuring, etc., may be performed by the transceiver circuitry configured to receive and/or transmit information 305 in certain contexts as being specific types of receive functions. In another example, functions such as sending, delivering, conveying, forwarding, etc., may be performed by the transceiver circuitry configured to receive and/or transmit information 305 in certain contexts as being specific types of transmit functions. Other functions that correspond to other types of receive and/or transmit functions may also be performed by the transceiver circuitry configured to receive and/or transmit information 305.

Referring to FIG. 3, the communications device 300 further includes at least one processor configured to process information 310. Example implementations of the type of processing that can be performed by the at least one processor configured to process information 310 includes but is not limited to performing determinations, establishing connections, making selections between different information options, performing evaluations related to data, interacting with sensors coupled to the communications device 300 to perform measurement operations, converting information from one format to another (e.g., between different protocols such as .wmv to .avi, etc.), and so on. For example, the at least one processor configured to process information 310 can include a general purpose processor, a DSP, an ASIC, a field programmable gate array (FPGA) or other programmable logic device, discrete gate or transistor logic, discrete hardware components, or any combination thereof designed to perform the functions described herein. A general purpose processor may be a microprocessor, but in the alternative, the at least one processor configured to process information 310 may be any conventional processor, controller, microcontroller, or state machine. A processor may also be implemented as a combination of computing devices (e.g., a combination of a DSP and a microprocessor, a plurality of microprocessors, one or more microprocessors in conjunction with a DSP core, or any other such configuration). The at least one processor configured to process information 310 can also include software that, when executed, permits the associated hardware of the at least one processor configured to process information 310 to perform its processing function(s). However, the at least one processor configured to process information 310 does not correspond to software alone, and the at least one processor configured to process information 310 relies at least in part upon structural hardware to achieve its functionality. Moreover, the at least one processor configured to process information 310 may be implicated by language other than “processing”, so long as the underlying function corresponds to a processing function. For an example, functions such as evaluating, determining, calculating, identifying, etc., may be performed by the at least one processor configured to process information 310 in certain contexts as being specific types of processing functions. Other functions that correspond to other types of processing functions may also be performed by the at least one processor configured to process information 310.

Referring to FIG. 3, the communications device 300 further includes memory configured to store information 315. In an example, the memory configured to store information 315 can include at least a non-transitory memory and associated hardware (e.g., a memory controller, etc.). For example, the non-transitory memory included in the memory configured to store information 315 can correspond to RAM, flash memory, ROM, erasable programmable ROM (EPROM), EEPROM, registers, hard disk, a removable disk, a CD-ROM, or any other form of storage medium known in the art. The memory configured to store information 315 can also include software that, when executed, permits the associated hardware of the memory configured to store information 315 to perform its storage function(s). However, the memory configured to store information 315 does not correspond to software alone, and the memory configured to store information 315 relies at least in part upon structural hardware to achieve its functionality. Moreover, the memory configured to store information 315 may be implicated by language other than “storing”, so long as the underlying function corresponds to a storing function. For an example, functions such as caching, maintaining, etc., may be performed by the memory configured to store information 315 in certain contexts as being specific types of storing functions. Other functions that correspond to other types of storing functions may also be performed by the memory configured to store information 315.

Referring to FIG. 3, the communications device 300 further optionally includes user interface output circuitry configured to present information 320. In an example, the user interface output circuitry configured to present information 320 can include at least an output device and associated hardware. For example, the output device can include a video output device (e.g., a display screen, a port that can carry video information such as USB, HDMI, etc.), an audio output device (e.g., speakers, a port that can carry audio information such as a microphone jack, USB, HDMI, etc.), a vibration device and/or any other device by which information can be formatted for output or actually outputted by a user or operator of the communications device 300. For example, if the communications device 300 corresponds to the UE 200A and/or UE 200B as shown in FIG. 2, the user interface output circuitry configured to present information 320 can include the display 210A or 205B. In a further example, the user interface output circuitry configured to present information 320 can be omitted for certain communications devices, such as network communications devices that do not have a local user (e.g., network switches or routers, remote servers, etc.). The user interface output circuitry configured to present information 320 can also include software that, when executed, permits the associated hardware of the user interface output circuitry configured to present information 320 to perform its presentation function(s). However, the user interface output circuitry configured to present information 320 does not correspond to software alone, and the user interface output circuitry configured to present information 320 relies at least in part upon structural hardware to achieve its functionality. Moreover, the user interface output circuitry configured to present information 320 may be implicated by language other than “presenting”, so long as the underlying function corresponds to a presenting function. For an example, functions such as displaying, outputting, prompting, conveying, etc., may be performed by the user interface output circuitry configured to present information 320 in certain contexts as being specific types of presenting functions. Other functions that correspond to other types of presenting functions may also be performed by the user interface output circuitry configured to present information 320.

Referring to FIG. 3, the communications device 300 further optionally includes user interface input circuitry configured to receive local user input 325. In an example, the user interface input circuitry configured to receive local user input 325 can include at least a user input device and associated hardware. For example, the user input device can include buttons, a touchscreen display, a keyboard, a camera, an audio input device (e.g., a microphone or a port that can carry audio information such as a microphone jack, etc.), and/or any other device by which information can be received from a user or operator of the communications device 300. For example, if the communications device 300 corresponds to UE 200A or UE 200B as shown in FIG. 2, the user interface input circuitry configured to receive local user input 325 can include the keypad 220A, the display 205B (if a touchscreen), etc. In a further example, the user interface input circuitry configured to receive local user input 325 can be omitted for certain communications devices, such as network communications devices that do not have a local user (e.g., network switches or routers, remote servers, etc.). The user interface input circuitry configured to receive local user input 325 can also include software that, when executed, permits the associated hardware of the user interface input circuitry configured to receive local user input 325 to perform its input reception function(s). However, the user interface input circuitry configured to receive local user input 325 does not correspond to software alone, and the user interface input circuitry configured to receive local user input 325 relies at least in part upon structural hardware to achieve its functionality. Moreover, the user interface input circuitry configured to receive local user input 325 may be implicated by language other than “receiving local user input”, so long as the underlying function corresponds to a receiving local user function. For example, functions such as obtaining, receiving, collecting, etc., may be performed by the user interface input circuitry configured to receive local user input 325 in certain contexts as being specific types of receiving local user functions. Other functions that correspond to other types of receiving local user input functions may also be performed by the user interface input circuitry configured to receive local user input 325.

Referring to FIG. 3, while the configured structural components of 305 through 325 are shown as separate or distinct blocks that are implicitly coupled to each other via an associated communication bus (not shown expressly), it will be appreciated that the hardware and/or software by which the respective configured structural components of 305 through 325 performs their respective functionality can overlap in part. For example, any software used to facilitate the functionality of the configured structural components of 305 through 325 can be stored in the non-transitory memory associated with the memory configured to store information 315, such that the configured structural components of 305 through 325 each perform their respective functionality (i.e., in this case, software execution) based in part upon the operation of software stored by the memory configured to store information 315. Likewise, hardware that is directly associated with one of the configured structural components of 305 through 325 can be borrowed or used by other of the configured structural components of 305 through 325 from time to time. For example, the at least one processor configured to process information 310 can format data into an appropriate format before being transmitted by the transceiver circuitry configured to receive and/or transmit information 305, such that the transceiver circuitry configured to receive and/or transmit information 305 performs its functionality (i.e., in this case, transmission of data) based in part upon the operation of structural hardware associated with the at least one processor configured to process information 310.

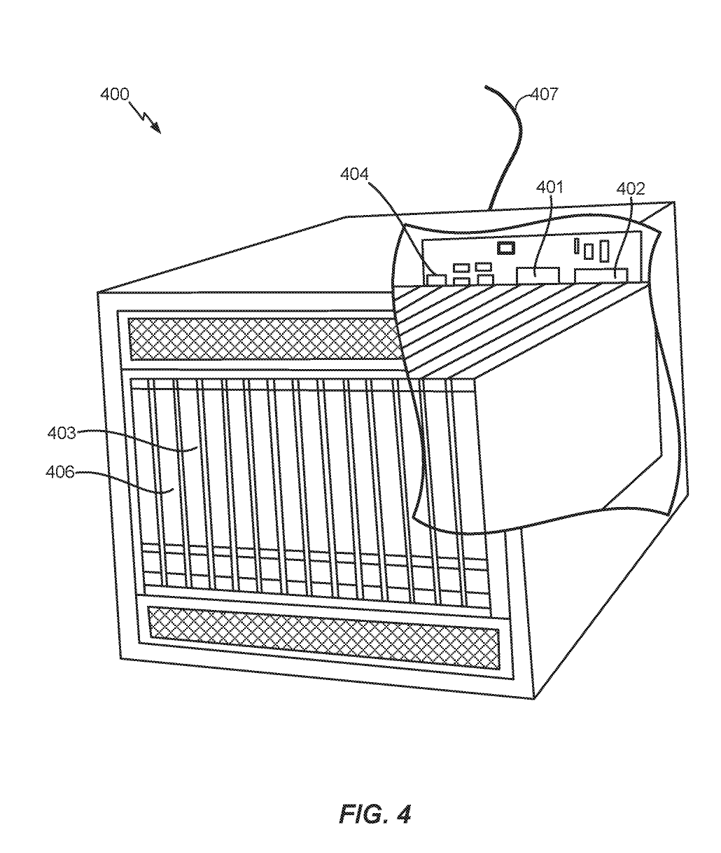

The various embodiments may be implemented on any of a variety of commercially available server devices, such as server 400 illustrated in FIG. 4. In an example, the server 400 may correspond to one example configuration of the application server 170 described above. In FIG. 4, the server 400 includes a processor 401 coupled to volatile memory 402 and a large capacity nonvolatile memory, such as a disk drive 403. The server 400 may also include a floppy disc drive, compact disc (CD) or DVD disc drive 406 coupled to the processor 401. The server 400 may also include network access ports 404 coupled to the processor 401 for establishing data connections with a network 407, such as a local area network coupled to other broadcast system computers and servers or to the Internet. In context with FIG. 3, it will be appreciated that the server 400 of FIG. 4 illustrates one example implementation of the communications device 300, whereby the transceiver circuitry configured to transmit and/or receive information 305 corresponds to the network access ports 404 used by the server 400 to communicate with the network 407, the at least one processor configured to process information 310 corresponds to the processor 401, and the memory configuration to store information 315 corresponds to any combination of the volatile memory 402, the disk drive 403 and/or the disc drive 406. The optional user interface output circuitry configured to present information 320 and the optional user interface input circuitry configured to receive local user input 325 are not shown explicitly in FIG. 4 and may or may not be included therein. Thus, FIG. 4 helps to demonstrate that the communications device 300 may be implemented as a server, in addition to a UE as in FIG. 2.

Various protocols exist for streaming media (e.g., video, audio, etc.) from a source device (hereinafter “Source”, such as a UE such as a phone, desktop computer, laptop, etc.) to one or more target display devices (referred to as a sink device or “Sink”). For example, a desktop or laptop computer may share a respective display screen with one or more target computers in a server-mediated session (e.g., GoToMeeting, etc.), or the streaming may occur via a local wireless media distribution scheme (e.g., Miracast). In a screen-sharing session, some or all of the media that is displayed at the Source is also sent to one or more Sinks. At times, a user of the Source may be prompted to enter private information (e.g., a passcode, a password, etc.) that he/she does not wish to share with the Sink(s) involved in the screen-sharing session and/or with one or more users in proximity to the Sink(s).

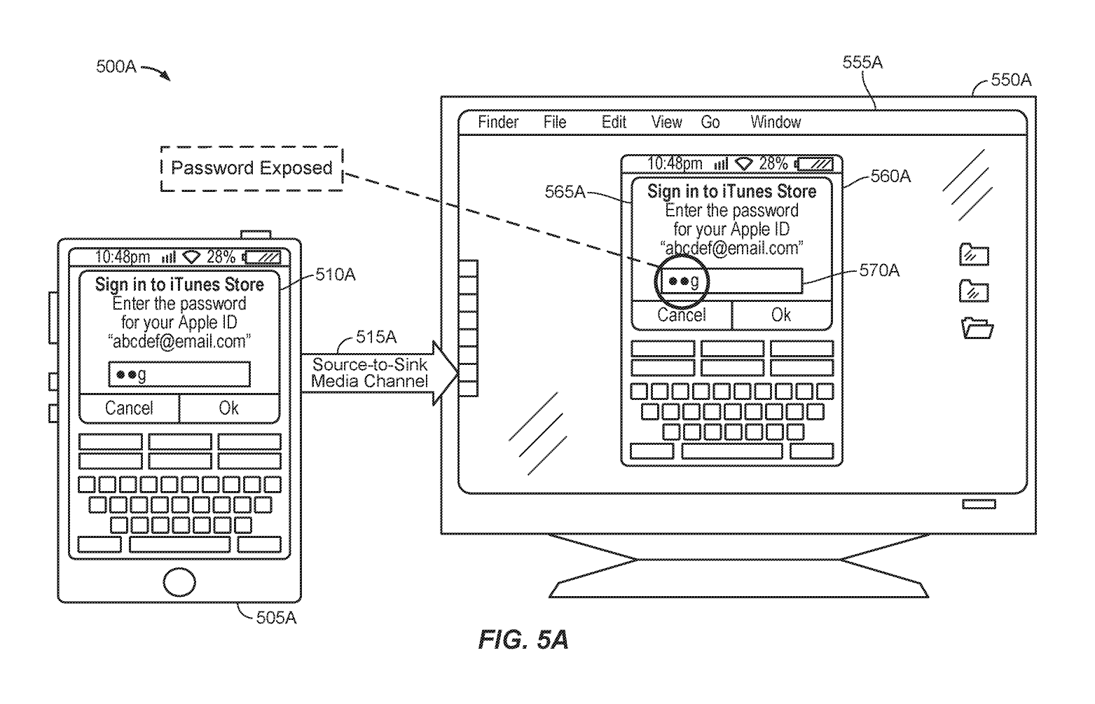

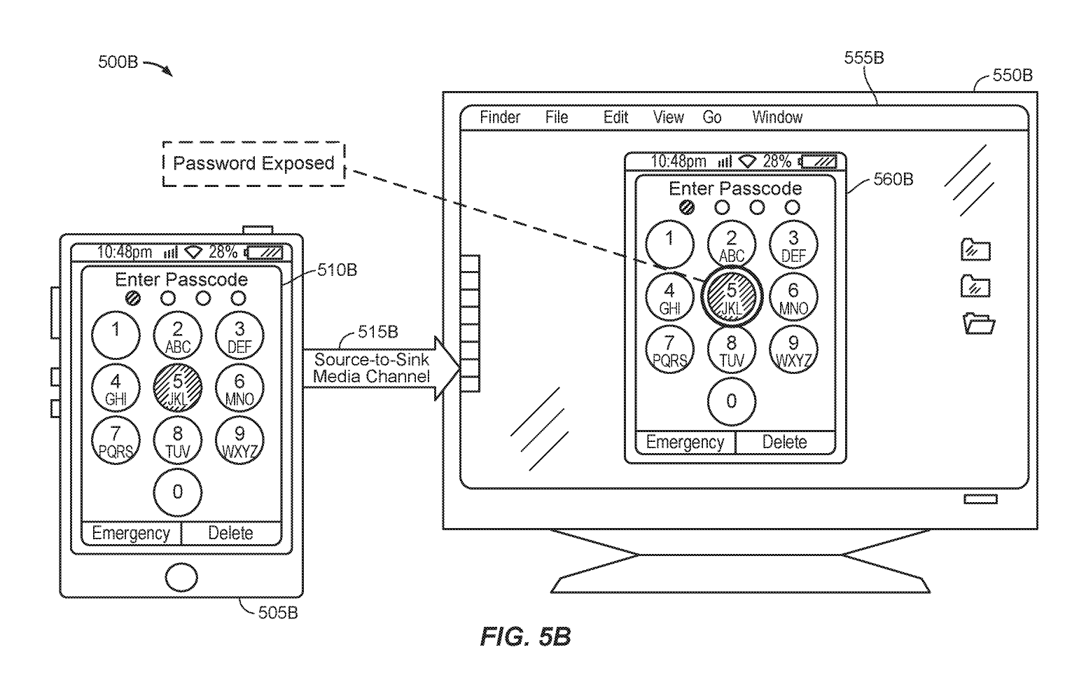

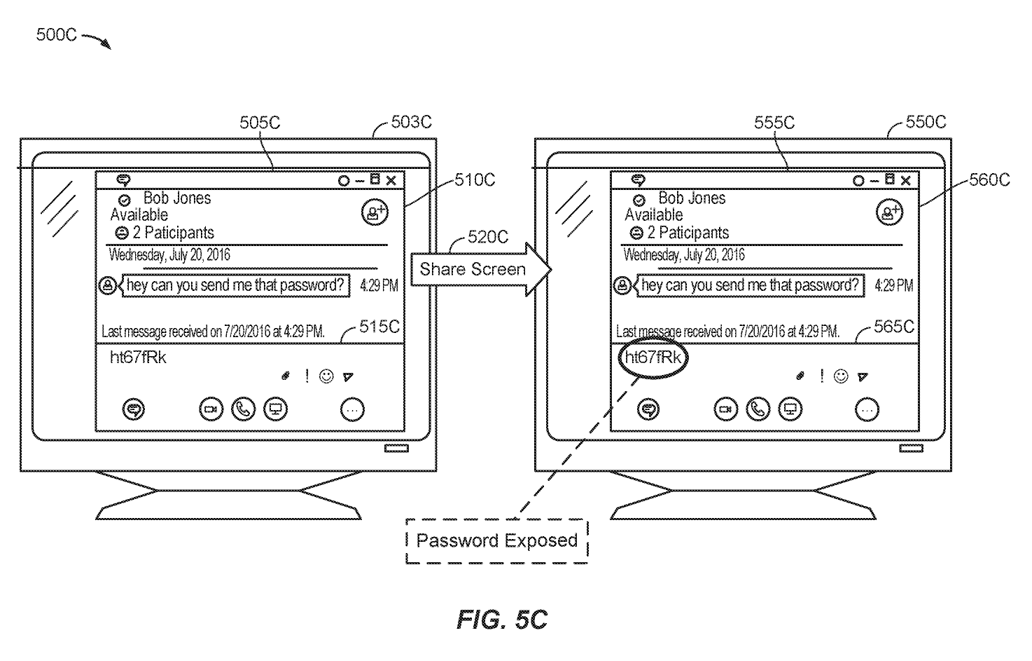

FIG. 5A illustrates a screen-sharing session 500A in accordance with an embodiment of the disclosure. In FIG. 5A, UE 505A (or Source) is engaged in a screen-mirror session with a UE 550A (e.g., a monitor) including display screen area 555A. Source 505A is displaying a first stream 510A of visual media while also streaming, via a Source-to-Sink media channel 515A (e.g., a Miracast channel, etc.), a second stream 560A of visual media that is presented within the display screen area 555A. The second stream 560A of visual media includes an iTunes password entry prompt 565A with a text entry section 570A where the Source user can enter his/her iTunes password. As the Source user enters the iTunes password via a user input interface (e.g., a keyboard, a touch screen, etc.) at the Source 505A, some of the iTunes password is also displayed by the UE 550A within the text entry section 570A. Accordingly, the Source user's iTunes password is at least partially exposed to anyone in view of the UE 550A.

FIG. 5B illustrates a screen-sharing session 500B in accordance with another embodiment of the disclosure. In FIG. 5B, Source 505B is engaged in a screen-mirror session with a Sink 550B including display screen area 555B. Source 505B is displaying a first stream 510B of visual media while also streaming, via a Source-to-Sink media channel 515B (e.g., a Miracast channel, etc.), a second stream 560B of visual media that is presented within the display screen area 555B at the Sink 550B. The second stream 560B of visual media includes a passcode entry prompt that includes digits that flash when the Source user selects a particular digit (or soft button) on Source 505B to unlock the Source 505B. Accordingly, the Source user's passcode is exposed to anyone in view of the Sink 550B.

FIG. 5C illustrates a screen-sharing session 500C in accordance with another embodiment of the disclosure. In FIG. 5C, Source 503C (e.g., a laptop or desktop computer) with display screen area 505C is engaged in a screen-sharing session with a Sink 550C (e.g., another laptop or desktop computer) including display screen area 555C. Source 503C is displaying a first stream of visual media while also streaming, via a media channel 520C (e.g., a server-mediated channel such as GoToMeeting, etc.), a second stream of visual media that is presented within the display screen area 555C. In FIG. 5C, the first and second streams of visual media encompass the entirety of the display screen areas 505C and 555C, respectively. The first stream of visual media includes an instant message window 510C with a text entry section 515C that is mirrored within the second stream of visual media as an instant message window 560C with a text entry section 565C. In this instance, a contact named Bob Jones (who is not necessarily the Sink user) is asking for a password that belongs to the Source user. As the Source user types in the password via a user input interface (e.g., a keyboard, a touch screen, etc.) at Source 503C, the password is exposed to anyone within view of Sink 550C via the text entry section 565C.

Embodiments of the disclosure relate to obfuscating a portion of a stream of visual media that is sent by a Sink to one or more Sink(s) during a screen-sharing session (e.g., a screen-mirror session, a session where less than all of the Source's screen is shared with the Sink(s), etc.). As will be discussed below in more detail, this permits the Source user to enter private or protected information which can be displayed at the Source without being transferred in a recognizable manner to the Sink(s).

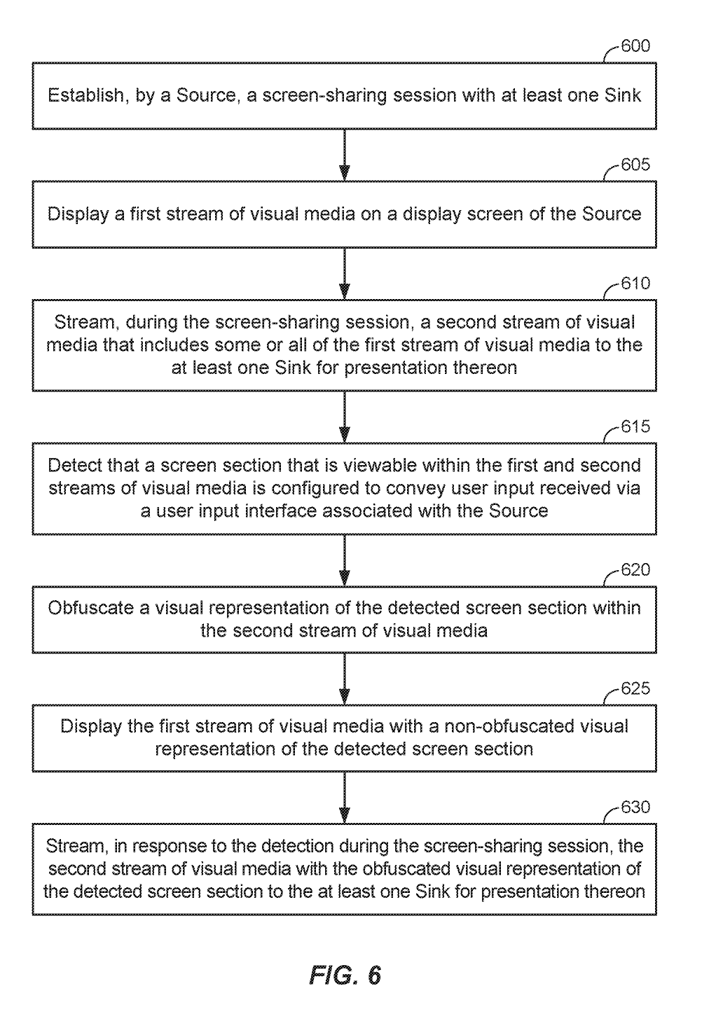

FIG. 6 illustrates a process of streaming media from a Source (e.g., a UE such as a smartphone, a tablet computer, a laptop or desktop computer, etc.) to at least one Sink (e.g., a monitor or smart monitor, a smartphone, a tablet computer, a laptop or desktop monitor, etc.) in accordance with an embodiment of the disclosure.

Referring to FIG. 6, the Source establishes a screen-sharing session with at least one Sink, 600. In an example, the screen-sharing session established at 600 may correspond to a local wireless media distribution session supported by a local wireless media distribution scheme such as Miracast. In another example, the screen-sharing session established at 600 may correspond to a session between two (or more) remote entities, such as a web conference that supports screen-sharing (e.g., GoToMeeting, etc.).

The Source displays a first stream of visual media on a display screen of the Source, 605, and also streams a second stream of visual media that includes some or all of the first stream of visual media to the at least one Sink for presentation thereon, 610. For example, if the screen-sharing session is a screen-mirror session, the pixels of the second stream of visual media may be substantially identical to the pixels of the first stream of visual media, although other types of differences between the streams may be present (e.g., the video timing of the at least one Sink may be different than the Source which may require separate frame buffers to accommodate, etc.). In an alternate example, the screen-sharing session may strip out certain content from the second stream of visual content. For example, if the screen-sharing session is a web conference session where a Source user is sharing his/her laptop or desktop screen with other web conference participant(s), the Source user may select an option to remove the taskbar from the screen-sharing session. So, the Source user can still view the taskbar on his/her screen during the session, but the other web conference participant(s) can view everything except for the taskbar. In another example, if the screen-sharing session is a web conference session where a Source user is sharing his/her laptop or desktop screen with other web conference participant(s), the Source user may have multiple screens while selecting an option to share only one of these multiple screens within the screen-sharing session. So, the Source user can still view all his/her screens, but the other web conference participant(s) can only view the Source user's designated shared screen.

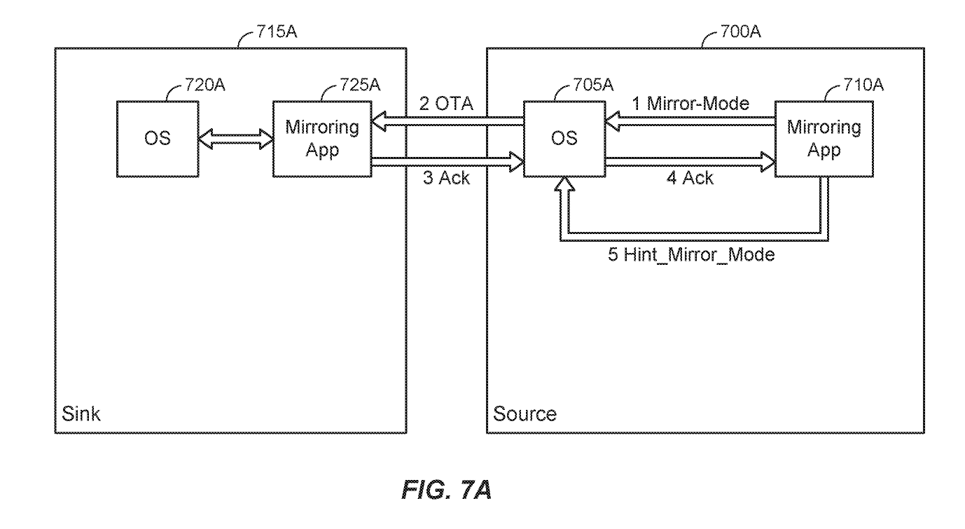

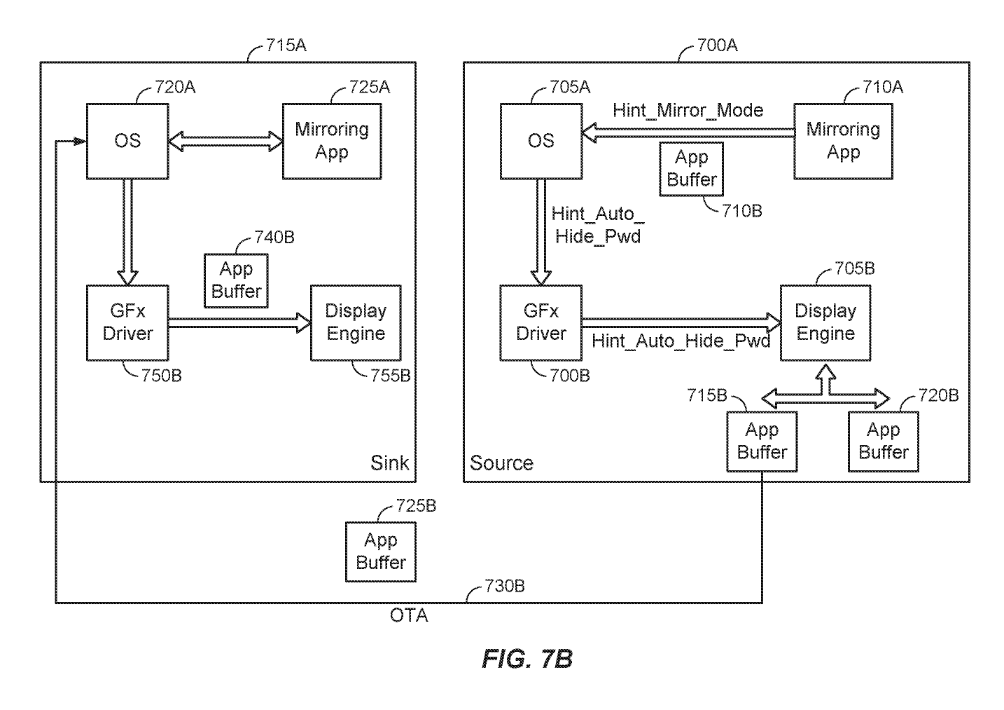

Referring to FIG. 6, the Source detects that a screen section that is viewable within the first and second streams of visual media is configured to convey user input received via a user input interface associated with the Source, 615. FIGS. 7A-7B illustrate one particular example framework to facilitate the detection of 615 with respect to a screen-minor session in accordance with an embodiment of the disclosure.

Referring to FIG. 7A, a Source 700A includes an operating system (OS) 705A (e.g., a high-level OS or HLOS, such as Android, iOS, etc.) and a mirroring application 710A (e.g., any media application that supports screen-mirroring, such as YouTube). The Source 700A is connected to a Sink 715A which includes an OS 720A (e.g., an HLOS, device firmware for a monitor, smart monitor or smart TV, etc.) and a mirroring application 725A. The minoring application 710A and/or 725A may be third party applications or built-in applications.

As the mirroring application 710A is launched, the minoring application 710A sends a mirror-mode signal (1) to the OS 705A, and the OS 705A creates a screen-mirror session via an over-the-air (OTA) connection (2) (e.g., WiFi, Miracast, etc.) with the mirroring application 725A on the Sink 715A. The Sink 715A ACKs (3) the screen- mirror session request, and the OS 705A forwards the ACK (4) to the mirroring application 710A. Once the screen-minor session is established, the mirroring application 710A sends a notification (5) or hint (denoted as Hint Mirror Mode in FIG. 7A) to the OS 705A so that the OS 705A is aware of the screen-mirror session.

Referring to FIG. 7B, additional components of the Source 700A and Sink 715A are depicted. In particular, the Source 700A further includes a graphics (GFx) driver 700B and a display engine 705B, and the Sink 715A further includes a GFx driver 750B and a display engine 755B. In an example, when the mirroring application 710A is launched (e.g., an email client, iTunes, etc.), an application buffer 710B is created, which can generate the Hint_Mirror_Mode event to the OS 705A. This Hint_Mirror_Mode can be generated either by the OS 705A itself on finding that the mirroring application 710A is launched and is prompting for username/password, or by maintaining a whitelist or blacklist of applications. Once the OS 705A gets the hint, the OS 705A sends a hint (e.g., Hint_Auto_Hide_Pwd) to the kernel driver, shown as GFx driver 700B in FIG. 7B, which passes the application buffer 710B after processing along with the Hint_Auto_Hide_Pwd to the display engine 705B. At the reception of Hint_Auto_Hide_Pwd, the display engine 705B creates two separate application buffers 715B and 720B for the Source 700A and the Sink 715A, respectively, and an OTA layer 730B (e.g., a WiFi layer) transmits a destination application buffer 725B to the OS 720A of the Sink 715A. An application buffer 740B may also be used when video frames are passed from the GFx driver 750B to the display engine 755B for presentation on the Sink 715A.

While FIGS. 7A-7B illustrate an example whereby the type of application launched at the Source during the screen-sharing session is how the detection of 615 occurs, in other embodiments the detection can occur in other ways. Also, the detection of 615 is not necessarily limited to password entry, but can relate to other types of user input (e.g., all text entry screens irrespective of the type of content entered thereon such as any word processing application or any instant messaging application, digits on a passcode entry panel, etc.).

Referring to FIG. 6, at 620, the Source obfuscates a visual representation of the detected screen section within the second stream of visual media. For example, an entire text entry portion that is viewable within the second stream of visual media can be blurred or greyed-out. In another example, the alphanumeric characters constituting a password in a password entry area can be replaced with asterisks within the second stream of visual media, while the alphanumeric characters constituting the password are left unchanged in the first stream of visual media being presented on the Source. In a further example, the obfuscation at 620 can be implemented at the GFx driver 700B and/or the display engine 705B depicted in FIG. 7B in response to the Hint_Auto_Hide_Pwd.

Referring to FIG. 6, the Source displays the first stream of visual media with a non-obfuscated visual representation of the detected screen section, 625, and the Source streams, in response to the detection of 615 during the screen-sharing session, the second stream of visual media with the obfuscated visual representation of the detected screen section to the at least one Sink for presentation thereon, 630.

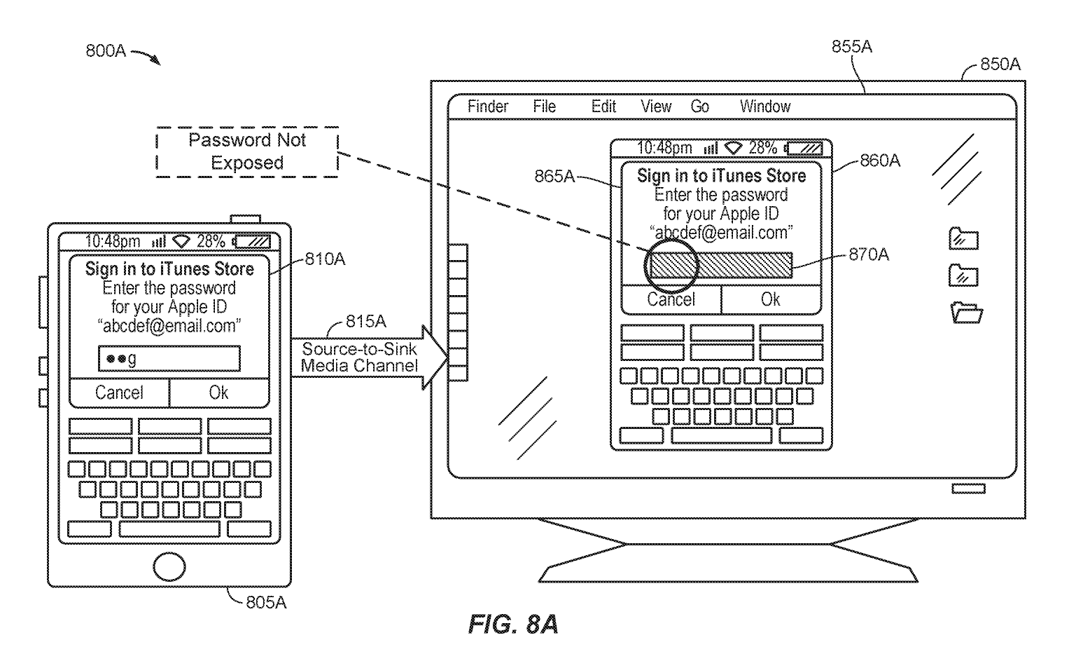

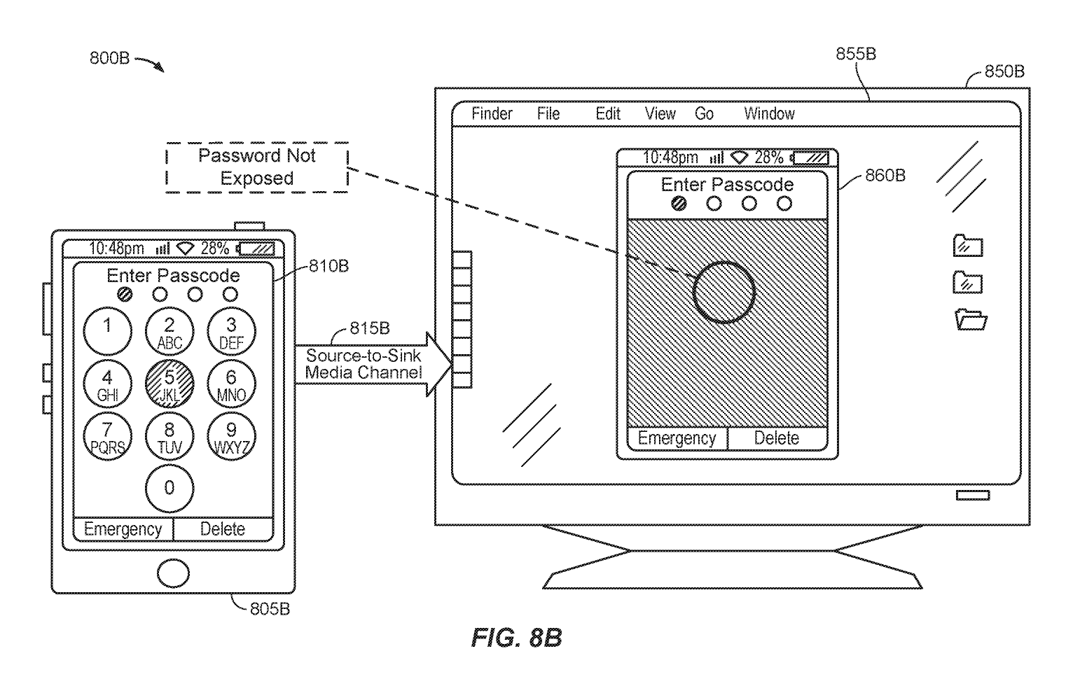

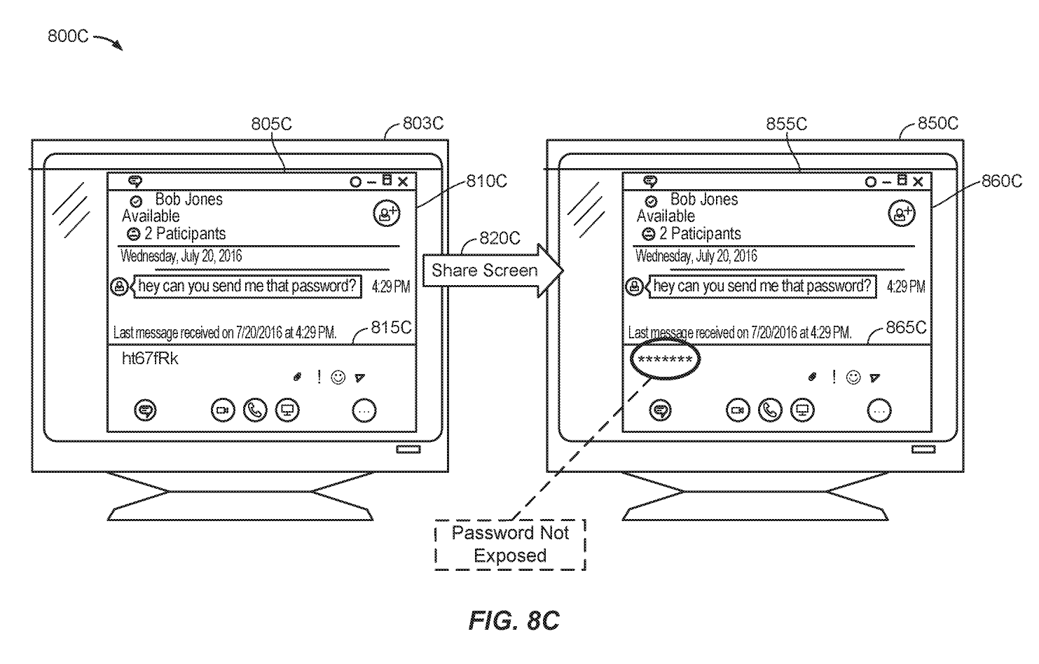

FIGS. 8A-8C illustrate screen sharing sessions in accordance with example implementations of the process of FIG. 6 in accordance with embodiments of the disclosure. More specifically, FIGS. 8A-8C illustrate modified versions of the screen-sharing sessions depicted in FIGS. 5A-5C.

FIG. 8A illustrates a screen-sharing session 800A in accordance with an embodiment of the disclosure. In FIG. 8A, UE 805A (or Source) is engaged in a screen-mirror session with a UE 850A (or Sink, e.g., a monitor) including display screen area 855A. Source 805A is displaying a first stream 810A of visual media while also streaming, via a Source-to-Sink media channel 815A (e.g., a Miracast channel, etc.), a second stream 860A of visual media that is presented within the display screen area 855A. The second stream 860A of visual media includes an iTunes password entry prompt 865A with a text entry section 870A where the Source user can enter his/her iTunes password. As the Source user enters the iTunes password via a user input interface (e.g., a keyboard, a touch screen, etc.) at the Source 805A, the text entry section 870A within the second stream 860A of visual media is grayed-out or blurred, such that the Source user's iTunes password is protected from the Sink user and/or any other people in proximity to the Sink 850A, in contrast to FIG. 5A. As will be appreciated, the graying-out or blurring of the text entry section 870A may be performed by the obfuscation at 620 of FIG. 6.

FIG. 8B illustrates a screen-sharing session 800B in accordance with another embodiment of the disclosure. In FIG. 8B, Source 805B is engaged in a screen-mirror session with a Sink 850B including a display screen area 855B. Source 805B is displaying a first stream 810B of visual media while also streaming, via a Source-to-Sink media channel 815B (e.g., a Miracast channel, etc.), a second stream 860B of visual media that is presented within the display screen area 855B at the Sink 850B. As the Source user enters a passcode to unlock the Source 805B (e.g., via a touch screen, etc.), the passcode entry prompt that includes digits that flash when the Source user selects a particular digit (or soft button) on the Source 805B to unlock the Source 805B is grayed-out or blurred on the Sink 850B, such that the Source user's passcode is protected from the Sink user and/or any other people in proximity to the Sink 850B, in contrast to FIG. 5B. As will be appreciated, the graying-out or blurring of the passcode entry prompt may be performed by the obfuscation at 620 of FIG. 6.

FIG. 8C illustrates a screen-sharing session 800C in accordance with another embodiment of the disclosure. In FIG. 8C, Source 803C (e.g., a laptop or desktop computer) with display screen area 805Cis engaged in a screen-sharing session with a Sink 850C (e.g., another laptop or desktop computer) including a display screen area 855C. Source 803C is displaying a first stream of visual media while also streaming, via a media channel 820C (e.g., a server-mediated channel such as GoToMeeting, etc.), a second stream of visual media that is presented within the display screen area 855C. In FIG. 8C, the first and second streams of visual media encompass the entirety of the display screen areas 805C and 855C, respectively. The first stream of visual media includes an instant message window 810C with a text entry section 815C that is mirrored within the second stream of visual media as an instant message window 860C with a text entry section 865C. In this instance, a contact named Bob Jones (who is not necessarily the Sink user) is asking for a password that belongs to the Source user. As the Source user types in the password via a user input interface (e.g., a keyboard, a touch screen, etc.) at Source 803C, the Source user's text entry is replaced with asterisks on the Sink 850C, such that the Source user's password is protected from the Sink user and/or any other people in proximity to the Sink 850C, in contrast to FIG. 5C. As will be appreciated, the replacement of text with asterisks within the text entry section 865C of the second stream of visual media may be performed by the obfuscation at 620 of FIG. 6.

Referring to FIGS. 8A-8C, it will be appreciated that FIGS. 8A-8B depict user input areas that are dedicated to conveying protected content (e.g., password entry prompts are only used to indicate password entries in contrast to non-protected or non- private content, passcode entry prompts are only used to indicate passcode entries in contrast to non-protected or non-private content, etc.). However, the text entry section 865C is configured to solicit any type of text that may or may not correspond to protected content. In this case, the obfuscation of the instant message text may occur as a precaution (e.g., even conversional text that is not private is obfuscated). Also, if the user sends the instant message than the text content will move from the text entry section 865C to the adjacent conversation history section. While not illustrated expressly in FIG. 8C, the entire instant message window may be obfuscated as a precaution in other embodiments of the disclosure.

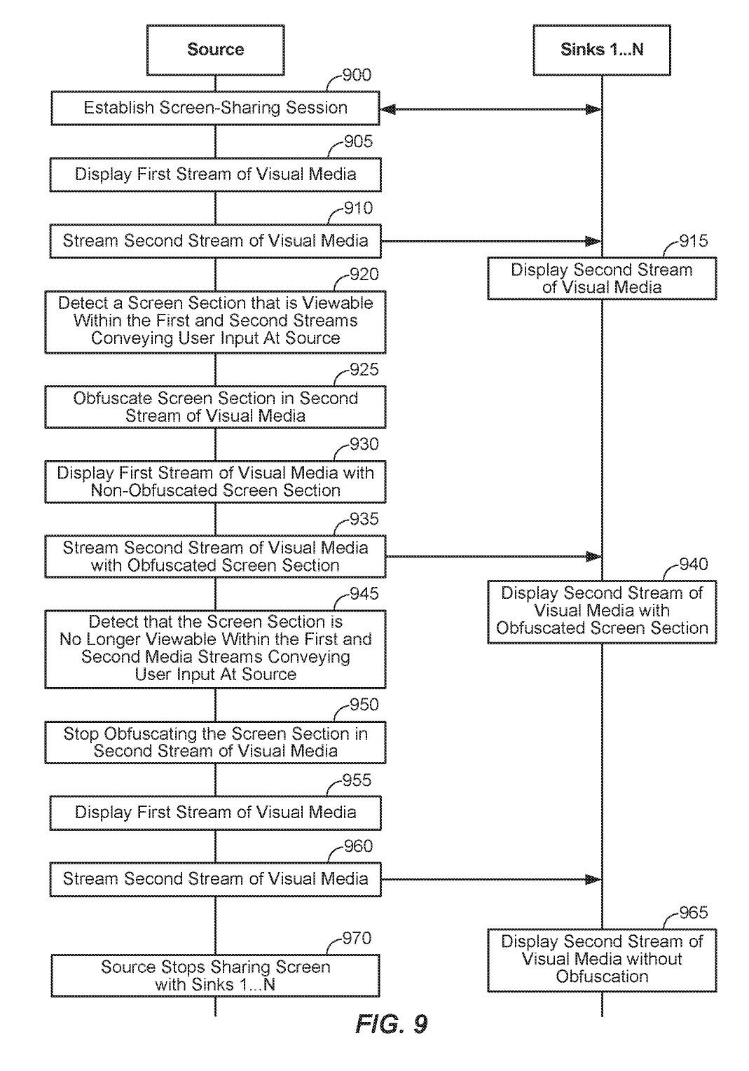

FIG. 9 illustrates an example implementation of the process of FIG. 6 in accordance with an embodiment of the disclosure. Referring to FIG. 6, a Source establishes a screen-sharing session with Sinks 1 . . . N (where N is an integer greater than or equal to 1), 900 (e.g., as in 600 of FIG. 6). As noted above, an OS at the Source may be notified of the screen-sharing session establishment (e.g., by a mirroring application, etc.) via a hint (e.g., Hint_Mirror_Mode). During the screen-sharing session, the Source displays a first stream of visual media, 905 (e.g., as in 605 of FIG. 6), while streaming a second stream of visual media to the Sinks 1 . . . N, 910 (e.g., as in 610 of FIG. 6). The Sinks 1 . . . N display the second stream of media, 915, which at this point does not include any obfuscated screen sections.

At some later point during the screen-sharing session, the Source detects a screen section that is viewable within the first and second streams of visual content that conveys user input (e.g., password, passcode, private instant message data, etc.) input by the Source user at the Source, 920 (e.g., as in 615 of FIG. 6). In an example, the detection at 920 (e.g., an application being launched on the Source, a particular type of window being displayed in the first and second streams of visual media, the Source operating in passcode entry mode for unlocking the Source, or any combination thereof) may be a triggering event that triggers delivery of a hint (e.g., Hint_Auto_Hide_Pwd) to a component (e.g., GFx driver 700B or display engine 705B) of the Source that places the component into a screen obfuscation mode. The Source obfuscates the screen section in the second stream of visual media, 925 (e.g., as in 620 of FIG. 6), displays the first stream of visual media with a non-obfuscated screen section on the Source, 930 (e.g., as in 625 of FIG. 6), while streaming the second stream of visual media with the obfuscated screen section to the Sinks 1 . . . N, 935 (e.g., as in 630 of FIG. 6). The Sinks 1 . . . N display the second stream of media with the obfuscated screen section, 940.

At some later point during the screen-sharing session, the Source detects that the screen section is no longer viewable within the second streams of visual content, 945. This can occur for a number of reasons, including the Source shutting down an application where the user input was previously displayed (e.g., closing an instant message window), the Source user completing entry of a password or passcode such that no private information is being displayed anymore, the Source user dragging a window displaying the user input to a section of the first stream of visual media that is not viewable in the second stream of visual media (e.g., to a secondary monitor that is not being shared as part of the screen-sharing session), and so on.

In an example, the detection of 945 may be a triggering event that triggers delivery of a hint to a component (e.g., GFx driver 700B or display engine 705B) of the Source to cause the component to exit out of screen obfuscation mode and stop performing the obfuscation of 925. In response to the detection at 945, the Source stops obfuscating the screen section in the second stream of visual media, 950. In an example, 950 may be facilitated by a supplemental hint delivered by the OS 705A at Source 700A to the GFx driver 700B and/to the display engine 705B that cancels or reverses the Hint_Auto_Hide_Pwd. At this point, the Source displays the first stream of visual media, 955, while streaming the second stream of visual media without any obfuscation to the Sinks 1 . . . N, 960. The Sinks 1 . . . N display the second stream of media, 965, which at this point no longer includes any obfuscated screen sections.

At some later point, the Source stops sharing its screen with the Sinks 1 . . . N, 970. This can occur for a number of reasons, such as the screen-sharing session being terminated, a different device being made presenter, and so on. In an example, 970 may trigger a supplemental hint delivered to the OS 705A at Source 700A indicating that the Source is no longer sharing the second stream of visual media with the at least one Sink (e.g., to cancel or reverse the Hint_Mirror_Mode). At this point, any resources allocated to supporting the second stream of visual media (e.g., application buffer 710B, 715B, 725B and/or 740B, etc.) can be released.

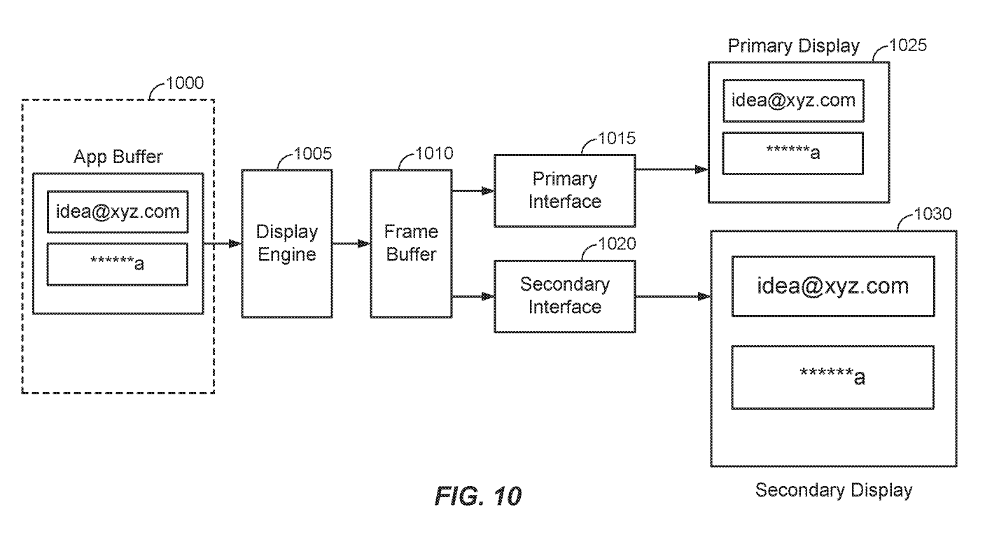

FIG. 10 illustrates a flow of media during a screen-sharing session when obfuscation of a screen section is not being performed in accordance with an embodiment of the disclosure. An application buffer 1000 includes a username and password. The application buffer 1000 is passed to a display engine 1005 and mapped to a particular screen section within display data. The display data is passed to a frame buffer 1010 (which may be representative of two frame buffers that store substantially the same pixels with slightly different characteristics such as screen-specific timing characteristics). The frame buffer 1010 generates a primary frame (to be displayed by the Source) which is passed to a primary interface 1015 and a secondary frame (to be displayed by the Sink) that is passed to a secondary interface 1020. No obfuscation is implemented in FIG. 10, so the screen sections 1025 and 1030 displaying the username and password are non-obfuscated on both a primary display at the Source and a secondary display at the Sink.

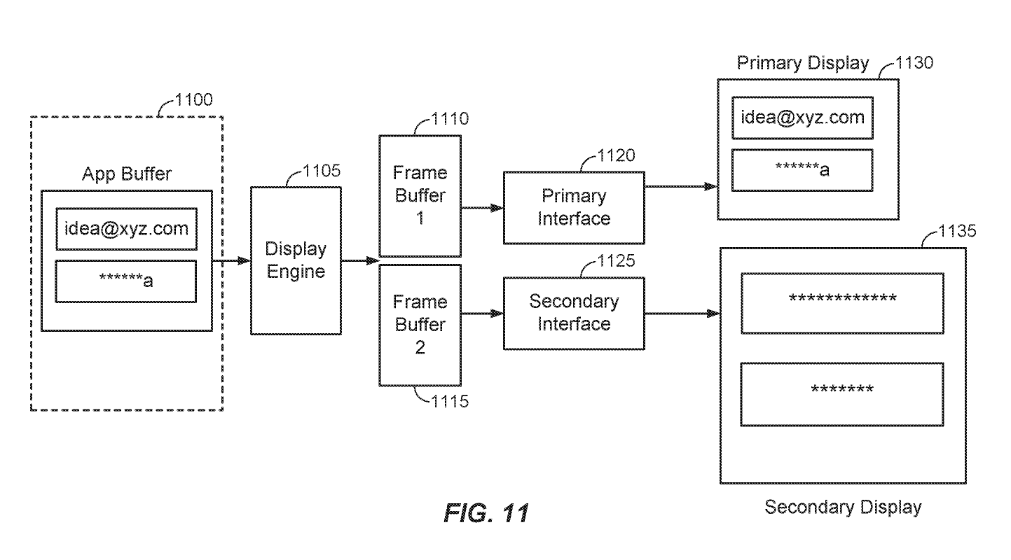

FIG. 11 illustrates a flow of media during a screen-sharing session when obfuscation of a screen section is being performed in accordance with an embodiment of the disclosure. An application buffer 1100 includes a username and password. The application buffer 1100 is passed to a display engine 1105 and mapped to non- obfuscated display data and obfuscated display data (with the password being obfuscated to all-asterisks). The non-obfuscated display data is passed to a first frame buffer 1110 and the obfuscated display data is passed to a second frame buffer 1115. The first frame buffer 1110 generates a primary frame (to be displayed by the Source) including the non-obfuscated display data which is passed to a primary interface 1120. The second frame buffer 1115 generates a secondary frame (to be displayed by the Sink) including the obfuscated display data which is passed to a secondary interface 1125. A screen section 1130 at the Source thereby displays the non-obfuscated display data, while a corresponding screen section 1135 at the Sink displays the obfuscated display data.

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Further, those of skill in the art will appreciate that the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The methods, sequences and/or algorithms described in connection with the embodiments disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a user terminal (e.g., UE). In the alternative, the processor and the storage medium may reside as discrete components in a user terminal.

In one or more exemplary embodiments, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of computer-readable media.

While the foregoing disclosure shows illustrative embodiments of the disclosure, it should be noted that various changes and modifications could be made herein without departing from the scope of the disclosure as defined by the appended claims. The functions, steps and/or actions of the method claims in accordance with the embodiments of the disclosure described herein need not be performed in any particular order. Furthermore, although elements of the disclosure may be described or claimed in the singular, the plural is contemplated unless limitation to the singular is explicitly stated.

What is claimed is:

1. A method of operating a Source, comprising:
establishing a screen-sharing session with at least one Sink;
displaying a first stream of visual media on a display screen of the Source;
streaming, during the screen-sharing session, a second stream of visual media that includes some or all of the first stream of visual media to the at least one Sink for presentation thereon;
detecting that a screen section that is viewable within the first and second streams of visual media is configured to convey user input received via a user input interface associated with the Source;
obfuscating a visual representation of the detected screen section within the second stream of visual media;
displaying the first stream of visual media with a non-obfuscated visual representation of the detected screen section; and
streaming, in response to the detecting during the screen-sharing session, the second stream of visual media with the obfuscated visual representation of the detected screen section to the at least one Sink for presentation thereon.

2. The method of claim 1, wherein the detected screen section corresponds to a user input area that is dedicated to conveying protected content.

3. The method of claim 2, wherein the protected content is a passcode or a password.

4. The method of claim 1,
wherein the screen-sharing session is a screen-mirror session, or
wherein the screen-sharing session is configured to share, with the at least one Sink, a modified version of visual media that is being output on the display screen of the Source.

5. The method of claim 1, wherein the screen-sharing session is supported via a local wireless media distribution scheme.

6. The method of claim 5, wherein the local wireless media distribution scheme is Miracast.

7. The method of claim 1, wherein the screen-sharing session is mediated by a server to which the at least one Sink is connected via an Internet connection.

8. The method of claim 1, further comprising:
notifying an operating system (OS) of the Source that the Source is engaged in the screen-sharing session.

9. The method of claim 8, further comprising:
detecting that the Source is no longer sharing the second stream of visual media with the at least one Sink; and
notifying the OS of the Source that the Source is no longer sharing the second stream of visual media with the at least one Sink.

10. The method of claim 1, further comprising:
notifying a component of the Source to trigger a screen obfuscation mode in response to a first triggering event,
wherein the obfuscating is performed by the component of the Source while operating in the screen obfuscation mode.

11. The method of claim 10, wherein the first triggering event includes an application being launched on the Source, a particular type of window being displayed in the first and second streams of visual media, the Source operating in passcode entry mode for unlocking the Source, or any combination thereof.

12. The method of claim 10, further comprising:
notifying the component of the Source to exit the screen obfuscation mode in response to a second triggering event,
wherein the obfuscating is terminated by the component of the Source in response to the second triggering event.

13. The method of claim 12, wherein the second triggering event includes an application being exited on the Source, a particular type of window being removed from the first and second streams of visual media, the Source exiting from a passcode entry mode for unlocking the Source, or any combination thereof.

14. The method of claim 10,
wherein the component is a display engine of the Source, or
wherein the component is a kernel or graphics driver of the Source.

15. The method of claim 1, further comprising:
detecting that the screen section that is no longer viewable within the second stream of visual media; and
terminating the obfuscating in response to the detection that the screen section is no longer viewable within the second stream of visual media.

16. The method of claim 1,
wherein the screen-sharing session is a screen-mirror session that uses a first frame buffer to generate the first stream of visual media and a second frame buffer to generate the second stream of visual media, and
wherein the obfuscating adds an overlay onto a portion of the second frame buffer corresponding to the detected screen section to produce the obfuscated visual representation of the detected screen section within the second stream of visual media.

17. A Source, comprising:
at least one processor coupled to a memory, transceiver circuitry and user interface output circuitry configured to present information, the at least one processor configured to:
establish a screen-sharing session with at least one Sink;
display a first stream of visual media on a display screen of the Source;
stream, during the screen-sharing session, a second stream of visual media that includes some or all of the first stream of visual media to the at least one Sink for presentation thereon;
detect that a screen section that is viewable within the first and second streams of visual media is configured to convey user input received via a user input interface associated with the Source;
obfuscate a visual representation of the detected screen section within the second stream of visual media;
display the first stream of visual media with a non-obfuscated visual representation of the detected screen section; and
stream, in response to the detection during the screen-sharing session, the second stream of visual media with the obfuscated visual representation of the detected screen section to the at least one Sink for presentation thereon.

18. The Source of claim 17,
wherein the screen-sharing session is supported via a local wireless media distribution scheme, or
wherein the screen-sharing session is mediated by a server to which the at least one Sink is connected via an Internet connection.

19. A non-transitory computer-readable medium containing instructions stored thereon which, when executed by a Source, cause the Source to perform operations, the instructions comprising:
at least one instruction to cause the Source to establish a screen-sharing session with at least one Sink;
at least one instruction to cause the Source to display a first stream of visual media on a display screen of the Source;
at least one instruction to cause the Source to stream, during the screen-sharing session, a second stream of visual media that includes some or all of the first stream of visual media to the at least one Sink for presentation thereon;
at least one instruction to cause the Source to detect that a screen section that is viewable within the first and second streams of visual media is configured to convey user input received via a user input interface associated with the Source;
at least one instruction to cause the Source to obfuscate a visual representation of the detected screen section within the second stream of visual media;
at least one instruction to cause the Source to display the first stream of visual media with a non-obfuscated visual representation of the detected screen section; and
at least one instruction to cause the Source to stream, in response to the detection during the screen-sharing session, the second stream of visual media with the obfuscated visual representation of the detected screen section to the at least one Sink for presentation thereon.

20. The non-transitory computer-readable medium of claim 19,
wherein the screen-sharing session is supported via a local wireless media distribution scheme, or
wherein the screen-sharing session is mediated by a server to which the at least one Sink is connected via an Internet connection.
